(19) United States
(12) Patent Application Publication
(10) Pub. No.: US 2015/0334558 A1
(43) Pub. Date: Nov. 19, 2015

(54) METHODS FOR CONFIGURING A MOBILE DEVICE AND RELATED MOBILE DEVICES

(71) Applicant: AthenTek Inc., Taipei City (TW)

(72) Inventors: Chun-Nan CHEN, Taipei City (TW); Kai HUANG, Taipei City (TW)

(21) Appl. No.: 14/468,125

(22) Filed: Aug. 25, 2014

Related U.S. Application Data
(60) Provisional application No. 61/993,562, filed on May 15, 2014.

(51) Int. Cl. H04W 8/22

(52) U.S. Cl. CPC H04W 8/22

(57) ABSTRACT

A method for configuring a mobile device is provided. First, a voice phone call dialed by a remote terminal is received in a standby mode. Thereafter, the voice phone call is rejected. Next, the mobile device is being waked up from the standby mode to a normal mode to perform at least one predetermined operation for controlling the mobile device.

### CROSS REFERENCE TO RELATED APPLICATIONS

This Application claims priority of U.S. Provisional Application No. 61/993,562, filed on May 15, 2014, and the entirety of which is incorporated by reference herein.

### BACKGROUND OF THE INVENTION

1. Field of the Invention

The invention generally relates to mobile devices and related methods thereof, and more particularly, to mobile devices and related methods for configuring a mobile device via a voice phone call.

2. Description of the Related Art

For a mobile device, consisting of a cellular modem and other sensors, without user interface, it needs to be configured remotely by a cloud server or a remote terminal. Conventionally, such mobile device may be configured by the cloud server or the remote terminal by using a Smart Message Service (SMS) message via a cellular base station or by using a push notice via a network connection such as an Internet connection. However, both of the conventional methods need additional telecom requirement, either to server or client side. For example, using a SMS message to configure the mobile device via the cellular base station may require additional telecom requirement for the server side, resulting in unnecessary cost. Moreover, using a push notice to configure the mobile device via a network connection may require a network module of the mobile device to be enabled to establish a network connection to the remote terminal so as to receive the push notice therefrom, resulting in additional network bandwidth and unnecessary power consumption.

### BRIEF SUMMARY OF THE INVENTION

Accordingly, embodiments of the invention provide mobile device and method for configuring a mobile device. In one aspect of the invention, a method for configuring a mobile device is provided. First, a voice phone call dialed by a remote terminal is received in a standby mode. Thereafter, the voice phone call is rejected. Next, the mobile device is being waked up from the standby mode to a normal mode to perform at least one predetermined operation for controlling the mobile device.

In another aspect of the invention, a mobile device is provided which comprises a storage device and a processor coupled to the storage device. The processor receives a voice phone call dialed by a remote terminal in a standby mode, rejects the voice phone call and wakes up the mobile device from the standby mode to a normal mode to perform at least one predetermined operation for controlling the mobile device.

In another aspect of the invention, a method for configuring a mobile device is provided. First, a voice phone call dialed by a remote terminal is received in a standby mode. It is then determined whether to reject the voice phone call according to a caller number of the remote terminal. When the caller number of the remote terminal is one of a set of predetermined caller numbers, the voice phone call is rejected and the mobile device is being woken up from the standby mode to a normal mode to perform a predetermined operation.

Other aspects and features of the present invention will become apparent to those with ordinarily skill in the art upon review of the following descriptions of specific embodiments of methods for configuring a mobile device for use in a mobile device.

### BRIEF DESCRIPTION OF DRAWINGS

The invention can be more fully understood by reading the subsequent detailed description and examples with references made to the accompanying drawings, wherein:

FIG. 1 is a block diagram illustrating a mobile device according to an embodiment of the invention;

FIG. 2 is a flow chart illustrating a method for configuring a mobile device according to an embodiment of the invention;

FIG. 3 is a flow chart illustrating a method for configuring a mobile device according to another embodiment of the invention;

FIG. 4 is a schematic diagram illustrating an embodiment of a state machine of the invention; and

FIG. 5 is a flow chart illustrating a method for configuring a mobile device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense.

Embodiments of the invention provide mobile devices and methods for configuring a mobile device thereof, which can configure the mobile device from a server (e.g. a cloud server) or remote terminal (e.g. a mobile phone) via a voice phone call without being picked up so as to trigger the mobile device to perform predetermined operations, thereby effectively reducing power consumption and saving cost.

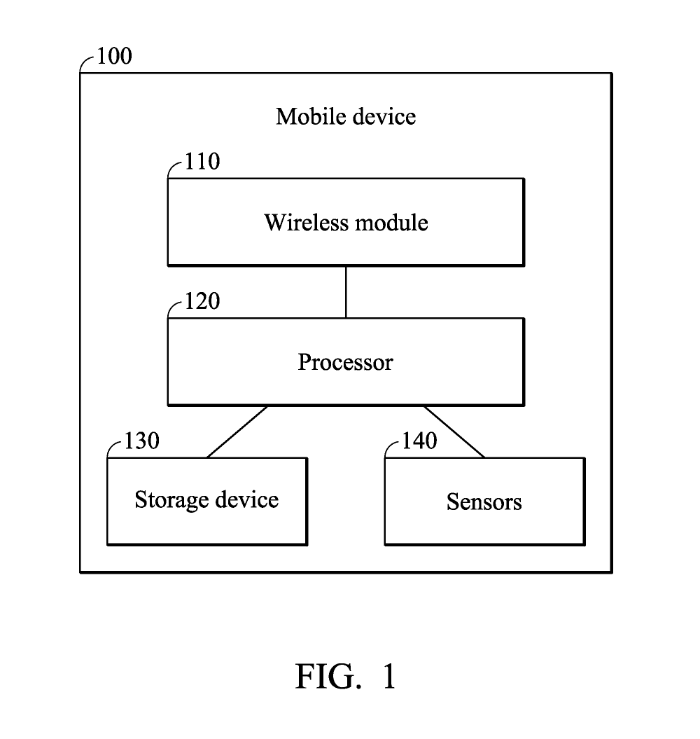

FIG. 1 is a schematic diagram illustrating an embodiment of a mobile device 100 according to the invention. The mobile device 100 may be a device that is not equipped with a user interface such as positioning devices for providing GPS location reporting and monitoring devices for monitoring a number of events. In some embodiments, the mobile device 100 may be a device that is equipped with a user interface, such as a mobile phone, a smart phone, or a PDA and so on. The mobile device 100 can be wirelessly connected to one or more remote terminals such as a cloud server so that the remote terminal can control the mobile device 100 remotely.

The mobile device 100 comprises a wireless module 110, a processor 120, a storage device 130 and one or more modules or sensors 140. The wireless module 110 receives signals from and transmits signals to a current associated network. It is to be understood that integrating the processor 120 into the wireless module 110 is also available. The wireless module 110 may be coupled to one or more antennas (not shown) and may allow communications with one or more additional devices, computers and/or servers using a wireless network. The mobile device 100 may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto. The processor 120 may be one or more data processors, image processors and/or central processors, which are capable of executing one or more types of computer readable medium stored in the storage device 140 such as a memory. In some embodiments, the wireless module 110 may be a cellular modem that provides mobile communication functionality based on the capabilities of the underlying hardware.

The storage device 130 may be a memory of the mobile device 100 and also may be an external storage card, such as a smart media (SM) card or secure digital (SD) card, for example. The sensors 140 may be turned on or off by the remote terminal. While being turned on, the sensor 140 will perform sensing operation to obtain a sensing result and report the sensing result to the remote terminal. For example, the sensor 140 may be a GPS sensor, a temperature sensor or a humidity sensor or other sensors, but the invention is not limited thereto. For example, when the mobile device 100 is a GPS device with a GPS sensor (e.g. a GPS receiver), the mobile device 100 can obtain a GPS signal using the GPS sensor, generate a GPS location according to the GPS signal and report the GPS location to the remote terminal.

The mobile device 100 may be operated in a normal mode or a standby mode (or also referred to a listening mode) by the processor 120. When the mobile device 100 is operated in the normal mode, powers of all its modules are turned on by the processor 120 so the mobile device 100 is capable of performing all operations, however, the power consumption will be significantly huge. During the standby mode of the mobile device 100, power for many unnecessary modules are turned off and only power for few necessary modules remain turned on by the processor 120 so as to receive incoming call from the remote terminal (e.g. a cloud server) and to save power.

The processor 120 which is coupled to the wireless module 110, the storage device 130 and the sensors 140 can perform the method for configuring a mobile device of the present invention, which will be discussed further in the following paragraphs. To be more specific, upon receiving a voice phone call dialed by a remote terminal under the standby mode, the processor 120 wakes up the mobile device 100 from the standby mode to the normal state to perform one or more predetermined operations.

Several embodiments of methods for configuring a mobile device are provided.

In some embodiments, the remote terminal may turn on or off a specific sensor or module of the mobile device via a voice phone call.

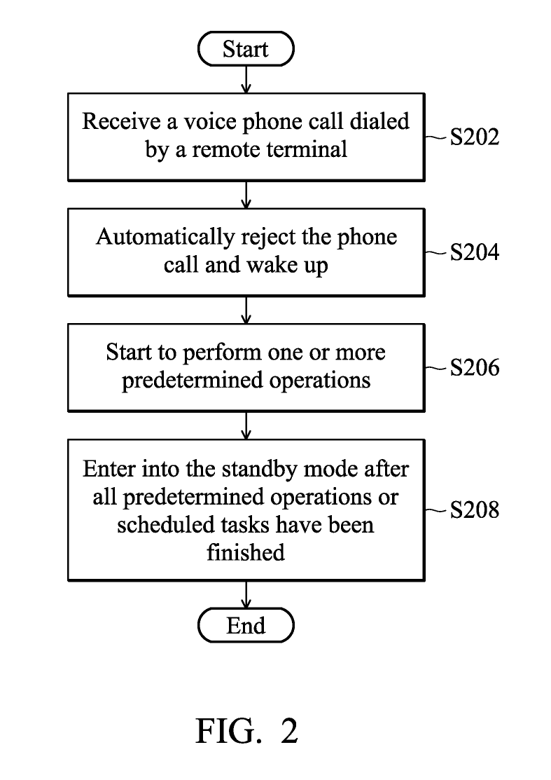

FIG. 2 is a flow chart illustrating a method for configuring a mobile device according to an embodiment of the invention. The method can be applied to the mobile device 100 as shown in FIG. 1. For example, the method can be performed by the processor 120 of the device 100 shown in FIG. 1. The mobile device 100 may be, for example, a mobile device that is not equipped with a user interface, such as a positioning device or a monitoring device. In this embodiment, the mobile device comprises a number of sensors or modules and may perform scheduled tasks using these sensors or modules. The mobile device 100 may first enter into the standby mode to save power consumption, wherein the sensors or modules 140 of the mobile device 100 are all being turned off for saving power.

When a remote terminal (e.g. a cloud server) wishes to configure the mobile device 100, the remote terminal dials a voice phone call to the mobile device 100 for configuring it, and thus, in step S202, the mobile device 100 receives a voice phone call dialed by the remote terminal. Upon reception of the voice phone call, in step S204, the mobile device 100 automatically rejects the phone call and wakes up.

Upon being woken up, in step S206, the mobile device 100 is triggered to start to perform one or more predetermined operations, such as performing a number of scheduled tasks, queuing jobs, server command, or sensing, measuring, or sniffing the surrounding radio.

After that, once receiving another voice phone call dialed by the cloud server or remote terminal, the mobile device 100 will reject the phone call and stop the performance of the predetermined operation and re-enter into or back to the standby mode again even if the predetermined operations are not finished.

After the mobile device finishes all predetermined operations or scheduled tasks, in step S208, the mobile device may enter into the standby mode again for power saving.

For example, when receiving a first voice phone call from the server, the mobile device rejects the voice phone call and wakes up to perform a predetermined operation such as turning on one or more sensors or modules (e.g. the GPS sensor or module) of the mobile device to perform scheduled tasks. In one embodiment, the sensor may be a GPS sensor, a temperature sensor or a humidity sensor or other sensors. While being turned on, the sensor will perform sensing operation to obtain a sensing result and report the sensing result to the remote terminal. Upon completion of the reporting, the sensor may automatically turn off and the mobile device enters into the standby mode again.

In some embodiments, each server or remote terminal may have a caller number and the mobile device may further determine which operation should be performed according to the caller number of the remote terminal.

For example, the predetermined operations may further comprise a first operation and a second operation, and the mobile device may determine whether to perform the first operation or the second operation according to the caller number of the remote terminal, wherein the mobile device will perform the first operation when the caller number of the remote terminal is a first predetermined number and it will perform the second operation when the caller number of the remote terminal is a second predetermined number.

In some embodiments, the method is performed without considering the caller number of the remote terminal. In other words, the mobile device 100 will automatically reject the phone call and wake up to start to perform one or more predetermined operations, such as turning on or off the GPS sensor, once receiving a voice phone call from any remote terminal.

In some embodiments, the storage device 130 may further store a set of predetermined caller numbers belong to a set of authorized servers or remote terminals which are allowed to control or configure the mobile device remotely. After rejecting the voice phone call and prior to being woken up, the processor 120 further determines whether to wake up the mobile device 100 from the standby mode to the normal mode to perform the predetermined operation according to the caller number of the remote terminal. Note that the mobile device is determined as not being woken up when the caller number of the remote terminal is none of a set of predetermined caller numbers. For example, if the set of predetermined caller numbers are numbers A, B and C, the mobile device is woken up when the caller number of the remote terminal is the number A, the number B or the number C while the mobile device is not being woken up when the caller number of the remote terminal is a number D other than the numbers A-C.

In some embodiments, the storage device 130 may further include a pre-defined state machine with a plurality of operation states and a list of caller numbers of pre-determined servers or remote terminals, wherein the remote terminal may direct or configure the mobile device to perform a state toggling for toggling the plurality of operation states of the predefined state machine within the mobile device via a voice phone call.

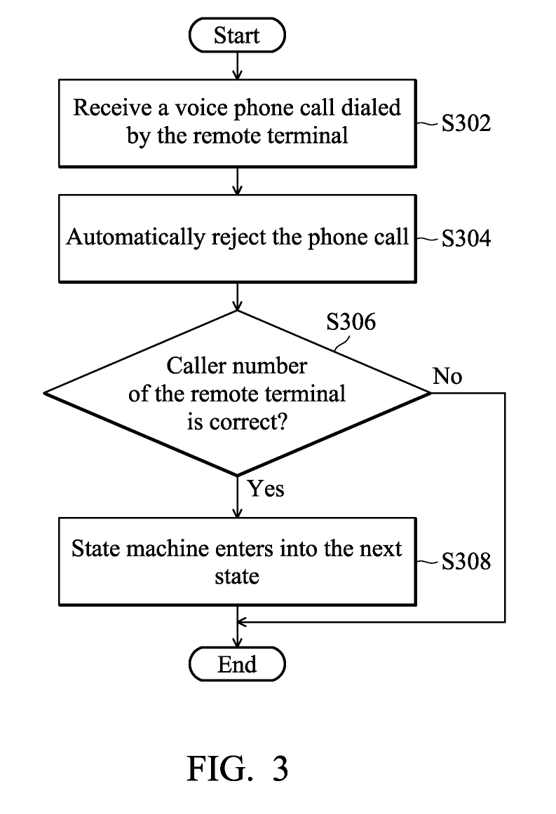

FIG. 3 is a flow chart illustrating a method for configuring a mobile device according to another embodiment of the invention. The method can be applied to the mobile device 100 and performed by the processor 120 as shown in FIG. 1. The mobile device 100 may be, for example, a mobile device that is not equipped with a user interface, such as a positioning device or a monitoring device. In this embodiment, the mobile device 100 may further include a pre-defined state machine with a plurality of operation states and a list of caller numbers of pre-determined servers or remote terminals stored in the storage device 130.

The mobile device may first enter into the standby mode to save power consumption. When a remote terminal (e.g. a cloud server) wishes to configure the mobile device 100 to perform a state toggling for toggling the plurality of operation states of the predefined state machine within the mobile device, the remote terminal dials a voice phone call to the mobile device 100 for configuring it, and thus, in step S302, the mobile device receives a voice phone call dialed by the remote terminal. The remote terminal may have a corresponding caller number (e.g. the telephone number for that remote terminal). Upon reception of the voice phone call, in step S304, the mobile device automatically rejects the phone call and checks if the caller number of the remote terminal is correct (step S306). For example, if the set of predetermined caller numbers are numbers A, B and C, the caller number of the remote terminal is determined as correct when the caller number of the remote terminal is the number A, the number B or the number C while the caller number of the remote terminal is determined as incorrect when the caller number of the remote terminal is a number D other than the numbers A-C.

When the caller number of the remote terminal is incorrect (No in step S306), which means that the voice phone call may be made by unauthorized terminals, the procedure ends and thus the state machine does not enter into the next state. Therefore, the state of the state machine keeps unchanged. When the caller number of the remote terminal is correct (Yes in step S306), in step S308, the state machine enters into the next state.

In one embodiment, the operation states of the state machine may be changed only by a remote terminal with a predetermined caller number. For example, only the voice phone call dialed by the remote terminal with a caller number of number A can configure the mobile device to toggle the operation states of its state machine.

In another embodiment, the operation states of the state machine may be changed by a remote terminal with a caller number within the list of predetermined caller numbers and each operation state may correspond to same or different caller numbers.

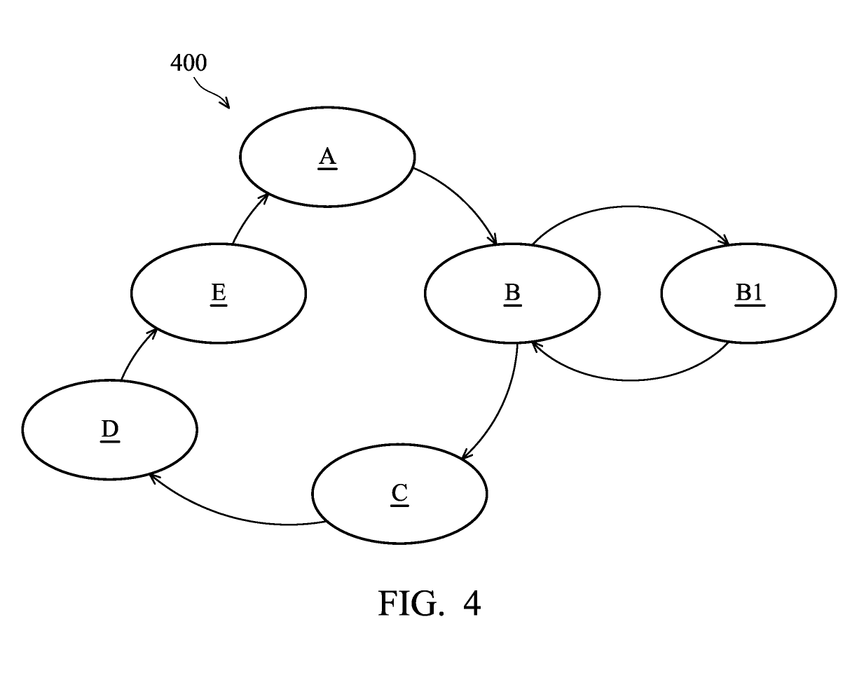

FIG. 4 is a schematic diagram illustrating an embodiment of a state machine of the invention. As shown in FIG. 4, the state machine 400 may comprise five operation states A, B, C, D and E, wherein the operation states of the state machine are sequentially changed from state A, B, C, D to E and the next state of E is back to A. Assume that the state machine 400 is started at state A. Once receiving a voice phone call from a first remote terminal with a caller number within the list of predetermined caller numbers, the operation state of the state machine is changed from current state A to the next state B. For example, if state A may configure the mobile device as “GSM listening”, “GPS off” (i.e. turning off the GPS sensor), “GPRS off” (i.e. turning off the GPRS module) and “WiFi off” (i.e. turning off the WiFi module) and state B may configure the mobile device as “GSM listening”, “GPS on” (i.e. turning on the GPS sensor), “GPRS off” and “WiFi off”, the GPS sensor will be turned on when the operation state of the state machine is changed from the state A to the state B. Accordingly, the GPS sensor may obtain current location information of the mobile device and report the obtained location information to the remote terminal regularly until the GPS sensor has been turned off.

After that, once receiving another voice phone call dialed by the server or remote terminal, the mobile device will reject the phone call and toggle the states within the state machine. For example, referring to FIG. 4, upon receiving another voice phone call from the first remote terminal, the operation state of the state machine is changed from current state B to the next state C and so on.

In some embodiments, as shown in FIG. 4, the state B may further comprise a sub-state B1 in which the mobile device is being configured as the GPRS module is turned on and returns to the state B if GPRS module is turned off. In this case, the operation state of the state machine is changed from the state B to the state C once receiving another voice phone call dialed by the first remote terminal or it is changed from the state B to the sub-state B1 once receiving another voice phone call dialed by a second remote terminal other than the first remote terminal.

In some embodiments, the mobile device may be a device with a user interface for answering the voice phone call, such as a handheld devices, such as a PDA (Personal Digital Assistant), a smart phone, a mobile phone, an MID (Mobile Internet Device, MID), a laptop computer, a car computer, a digital camera, a multi-media player, a game device, or any other type of mobile computational device, however, it is to be understood that the invention is not limited thereto, and the mobile device may further determine whether to answer the phone call or to reject it and perform predetermined operations according to the caller number of the remote terminal.

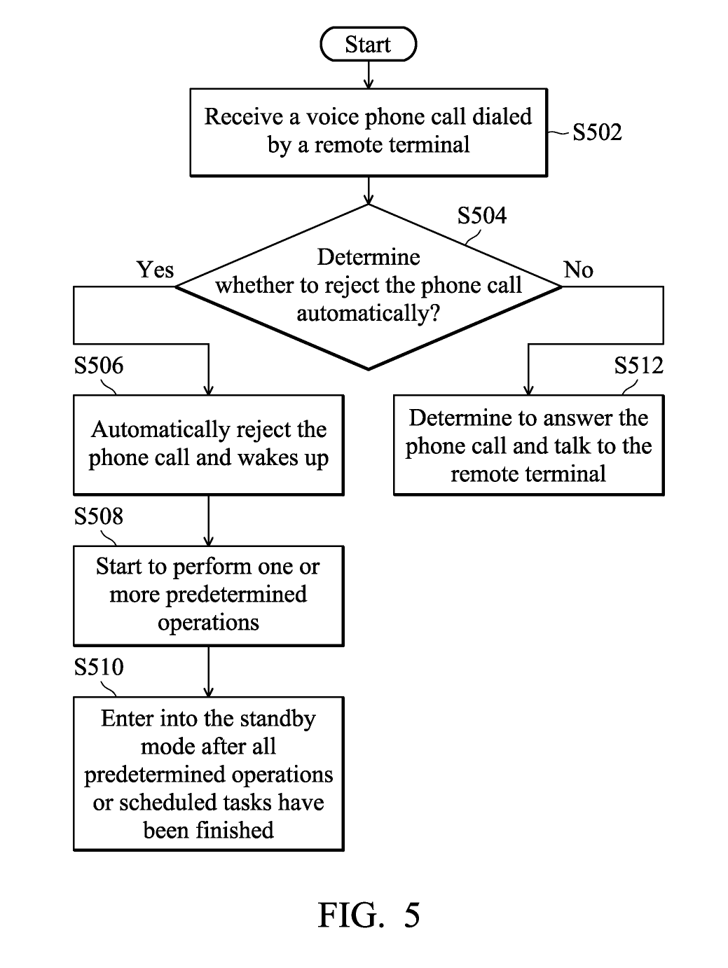

FIG. 5 is a flow chart illustrating a method for configuring a mobile device according to another embodiment of the invention. The method can be applied to the mobile device 100 and performed by the processor 120 as shown in FIG. 1. The mobile device 100 may be, for example, a mobile device that is equipped with a user interface, such as a PDA (Personal Digital Assistant), a smart phone, a mobile phone, an MID (Mobile Internet Device, MID), a laptop computer, a car computer, a digital camera, a multi-media player, a game device, or any other type of mobile computational device, however, it is to be understood that the invention is not limited thereto. In this embodiment, the mobile device comprises a number of sensors or modules and may perform scheduled tasks using these sensors or modules. In this embodiment, the mobile device may first enter into the standby mode (e.g. the listening mode) to save power consumption.

Upon receiving a voice phone call dialed by a remote terminal (step S502), the mobile device first determines whether to reject the phone call automatically according to a caller number of the caller (step S504). When the caller number of the caller is one of a set of predetermined caller numbers (Yes in step S504), which means that the phone call is initialized by a known server for configuration, the mobile device automatically rejects the phone call and wakes up (step S506) and upon being woken up, the mobile device is triggered to start to perform one or more predetermined operations (step S508), such as performing a number of scheduled tasks, queuing jobs, server command, or sensing, measuring, or sniffing the surrounding radio.

After that, once receiving another voice phone call dialed by the remote terminal which is one of the known servers, the mobile device will reject the phone call and stop performing the predetermined operation and enter into the standby mode again even if the predetermined operations are not finished.

After the mobile device finishes all predetermined operations or tasks, the mobile device enters into the standby mode again for power saving (step S510).

For example, when receiving a first voice phone call from the server, the mobile device rejects the voice phone call and wakes up to perform a predetermined operation such as turning on one or more sensors or modules of the mobile device to perform scheduled tasks.

In one embodiment, the sensor may be a GPS sensor, a temperature sensor or a humidity sensor or other sensors. While being turned on, the sensor will perform sensing operation to obtain a sensing result and report the sensing result to the remote terminal. Upon completion of the reporting, the sensor may automatically turn off and the mobile device enters into the standby mode again.

Contrarily, when the caller number of the remote terminal is none of the set of predetermined caller numbers (No in step S504), which means that it is a normal incoming call, the mobile device may determine to answer the phone call and talk to the remote terminal (step S512).

In summary, the mobile devices and methods for configuring a mobile device of the invention can configure the mobile device from a remote terminal via a voice phone call without being picked up so as to trigger the mobile device to perform predetermined operations, thereby effectively reducing power consumption and saving cost.

Methods or certain aspects or portions thereof, may take the form of a program code (i.e., executable instructions) embodied in tangible media, such as floppy diskettes, CD-ROMS, hard drives, or any other non-transitory machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for a mobile device, comprising:
receiving a voice phone call dialed by a remote terminal in a standby mode;
rejecting the voice phone call; and
waking up the mobile device from the standby mode to a normal mode to perform at least one predetermined operation for controlling the mobile device.

2. The method of claim 1, wherein the at least one predetermined operation further comprises turning on or off a specific sensor or module of the mobile device.

3. The method of claim 2, wherein the specific sensor is a GPS sensor, a temperature sensor or a humidity sensor.

4. The method of claim 1, wherein the at least one predetermined operation further comprises performing a state toggling for toggling a plurality of operation states of a predefined state machine within the mobile device.

5. The method of claim 1, wherein the at least one predetermined operation further comprises a first operation and a second operation, and the method further comprises:
performing the first operation when a caller number of the remote terminal is a first predetermined number; and
performing the second operation when the caller number of the remote terminal is a second predetermined number.

6. The method of claim 1, further comprising:
receiving another voice phone call dialed by the remote terminal in the normal mode; and
rejecting the another voice phone call and stopping the performance of the at least one predetermined operation in response to rejection of the another voice phone call.

7. The method of claim 1, further comprising:
entering into the standby mode from the normal mode upon completion of the at least one predetermined operation.

8. The method of claim 1, wherein the mobile device is a device that is not equipped with a user interface.

9. The method of claim 1, further comprising:
after rejecting the voice phone call, determining whether to wake up the mobile device from the standby mode to the normal mode to perform the at least one predetermined operation according to a caller number of the remote terminal,
wherein the mobile device is determined as not being woken up when the caller number of the remote terminal is none of a set of predetermined caller numbers.

10. A mobile device, comprising:
a storage device; and
a processor coupled to the storage device, receiving a voice phone call dialed by a remote terminal in a standby mode, rejecting the voice phone call and waking up the mobile device from the standby mode to a normal mode to perform at least one predetermined operation for controlling the mobile device.

11. The mobile device of claim 10, further comprising a specific sensor or module, wherein the processor further performs the at least one predetermined operation by turning on or off the specific sensor or module of the mobile device.

12. The mobile device of claim 11, wherein the specific sensor is a GPS sensor, a temperature sensor or a humidity sensor.

13. The mobile device of claim 10, wherein the storage device further includes a predefined state machine with a plurality of operation states and the processor further performs the at least one predetermined operation by performing a state toggling for toggling the plurality of operation states of the predefined state machine within the storage device of the mobile device.

14. The mobile device of claim 10, wherein the at least one predetermined operation further comprises a first operation and a second operation, and the processor further performs the first operation when a caller number of the remote terminal is a first predetermined number and performs the second operation when the caller number of the remote terminal is a second predetermined number.

15. The mobile device of claim 10, wherein the processor further receives another voice phone call dialed by the remote terminal in the normal mode, rejects the another voice phone call and stops the performance of the at least one predetermined operation in response to rejection of the another voice phone call.

16. The mobile device of claim 10, wherein the processor further enters into the standby mode from the normal mode upon completion of the at least one predetermined operation.

17. The mobile device of claim 10, wherein the mobile device is a device that is not equipped with a user interface.

18. A method for configuring a mobile device, comprising:
receiving a voice phone call dialed by a remote terminal in a standby mode;
determining whether to reject the voice phone call according to a caller number of the remote terminal; and
when the caller number of the remote terminal is one of a set of predetermined caller numbers, rejecting the voice phone call and waking up the mobile device from the standby mode to a normal mode to perform a predetermined operation.

19. The method of claim 18, further comprising:
when the caller number of the remote terminal is none of the set of predetermined caller numbers, determining to answering the voice phone call.

20. The method of claim 18, wherein the at least one predetermined operation further comprises turning on or off a specific sensor or module of the mobile device.
